(19) United States
(12) Patent Application Publication
(10) Pub. No.: US 2006/0074961 A1
(43) Pub. Date: Apr. 6, 2006

(54) Method and information database structure for faster data access

(75) Inventors: George Kongalath, St-Laurent (CA); Bradley Mills, Deux-Montagnes (CA)

Correspondence Address: Alex Nicolaescu;Ericsson Canada Inc., Patent Department, 8400 Decarie Blvd., Town Mount Royal, QC, H4P 2N2, CA

(73) Assignee: Telefonaktiebolaget L M Ericsson

(21) Appl. No.: 10/948,144

(22) Filed: Sep. 24, 2004

(51) Int. Cl. G06F 7/00

(52) U.S. Cl. 707/102

(57) ABSTRACT

A method and information database structure, wherein at least one data field are given a priority level indication, depending on the importance of the data stored therein. When a query request is received, the query is translated into a plurality of queries, one for each level of priority available in the database, and the information is retrieved based on its priority. Typically, high priority information, which may be critical for the requestor, is retrieved first, since it may also be easier to access, and is thus returned faster to the requestor. Low priority information may take a longer time to be accessed since it may contain larger portions of data. When the low priority information is also retrieved, it is further returned to the requestor.

### BACKGROUND OF THE INVENTION

1. Field of the Invention

The present invention relates to databases, and in particular to a method and database structure for optimizing database information access time.

2. Description of the Related Art

A database is a collection of information that is organized so that it can be easily accessed, managed, and updated. In the computing environment, databases are sometimes classified according to their organizational approach. The most prevalent approach is the relational database, a tabular database in which data is defined so that it can be organized and accessed in a number of different ways. A distributed database is one that can be dispersed and replicated among different points in a network. Finally, an object-oriented programming database is one that is congruent with the data defined in object classes and subclasses. Computer databases typically contain aggregations of data records or files, such as for example sales transactions, product catalogs, inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language used for interacting with database engines for administrative tasks and for queries that retrieve and update a database. SQL is available on products such as IBM's DB2™, Microsoft's Access™, and on other database products from companies like Oracle, Sybase, and Computer Associates. SQL statements are used both for interactive queries for information from a relational database and for gathering data for reports. Although SQL is both an ANSI (American National Standards Institute) and an ISO (International Standard Organization) standard, many database products support SQL with proprietary extensions to the standard language. Queries take the form of command language that lets the user select, insert, update, locate records and perform functions on the data, and so forth.

A relational database may also consist in a collection of data items organized as a set of formally-described tables from which data can be accessed in various ways without having to reorganize the basic structure of the database tables. Data can also be indexed with rules for attribute relations and triggers that activate based on events related to records in the table. In addition to being relatively easy to create and access, a relational database has the important advantage of being easy to extend. After the original database creation, a new data category can be added without requiring that all existing applications be modified. A relational database is a set of one or more tables containing data fitted into predefined categories. Each table contains one or more data categories, called data fields, which are typically arranged in columns. Each row, called data record, contains a unique instance of data, called information element or entry, for the categories defined by the columns (the data fields). A user of the database can obtain views of the database information of interest that are based on the connection of one or more fields from one or more tables that belong to the database. When creating a relational database, one can also define the domain of possible values in each one of the database's fields by defining field attributes, thus applying constraints to data values contained in the database's fields, such as for example the nature of the field (e.g. text, or numeral, etc), the length of the field (e.g. 256 characters, or numeral with 2 decimals, etc), or the range of the field (numeral ranging from 0 to 1000, etc). The definition of a relational database results in a table of metadata, which is a definition, or description of data included in a database.

In the last decades, databases have become an important factor in the industry. From small retail stores to the mega corporate giants and the telecom industry, management of data is a vital element and is most always performed with the use of information databases. Data storage assumes a media where the storage engine places all the database's information. In most cases, the physical storage comprises a Hard Disk Drive (HDD), while in other cases it may comprise a Random Access Memory (RAM) or Flash disk. There are trends in the industry to store certain tables of a given database structure in RAM and others on an HDD. The difficulty posed by this implementation is that an application requesting data from the database engine has to make separate calls to the database engine to retrieve information. The advantage of such implementation is that the response from RAM storage is much faster than that from the disk (e.g. high nanoseconds to low microseconds range versus milliseconds range) and even than that of flash disks, as in this former case a data transfer call has to go through a data access interface, which induces a significant access time overhead.

In relational tables, a BLOB (Binary Large Object) type is the only data type that is normally stored as a pointer reference. The pointer reference is controlled by a database engine that assigns a storage location to the BLOB data to the normal storage media. But even in the latest database application “mySOL cluster”, the BLOB storage is only applicable to HDD-stored media. Binary large objects are usually blocks of data where the size of the data block can be variable, like in the case of pictures, sound clips etc. Variable sizes are not preferred in a standard database engines as they make framing the data segments complicated. Memory (e.g. RAM) databases find BLOBs an oddity as they are generally used to work with 8-bit pointers and since it is cost effective to store larger data segments on disk, rather than in a memory, and reference it with a pointer. However, this implementation of BLOBs on disks makes the data stored therein unavailable to applications that require fast data access, such as in the range of microseconds or low milliseconds.

A problem posed by existing solutions is therefore that they do not always support the required speed for accessing data elements of a given database when such elements are of various types. For example, in a given data record, there may be information elements of various types and sizes, such as for example text elements along with biometric templates, sound clips and pictures in BITMAP graphical format. Some of these elements oftentimes need to be accessed in the range of a few micro-seconds, others only need to be accessed in the range of milliseconds, while there will be yet other elements that need to be accessed in a few seconds.

Differentiating between the relative access time of data elements can be critical for an application, as it makes a tremendous difference in the method of referencing, storing and retrieving data. This implicitly impacts, the cost and the reliability of the database system.

For example, let us consider the average telecom subscriber with a basic mobile phone subscription, with email, Multimedia Messaging Service (MMS), Wireless Application Protocol (WAP) access, location-based service, Short Messaging System (SMS), etc. The subscriber can further have a number of personalized ring tones and pre-call announcements. All the subscriber profile information including the above-mentioned information is stored in a database of a Home Subscriber System (HSS) node of the mobile telephone network. When the subscriber registers his mobile phone with the network, all data elements from his associated data record of the HSS database required for the network registration are needed immediately. On the other hand, access to the list of possible ring tones or pre-call announcements is only needed when the subscriber needs to change the current setting. Only certain data from the subscriber record is needed at any given time, while the rest are needed during re-configuration or referencing.

Storing all subscriber information in a subscriber record in a high speed access area such as RAM is uneconomical, while areas such as disk (HDD) are inefficient, as large data elements that are the slowest to be accessed would also slow down the access of all other smaller but essential elements of that record. For example, when accessing an entire subscriber record of a given database, in current implementations the system must first lock the entire record for a safe read (so that no other database transaction can modify the data during the read), and then attempt to read the record and return the information to the requester. This process involves identifying the record position in the data file (an offset from a sector location on disk, and then either reading the whole record and parse the required fields from the data stream or skipping offsets to the required fields (the offset is defined in the metatable) and reading the data. Thus, the reading process is slow due to the offset reading and/or parsing. As the data elements get larger, the speed of access slows down the reading and further impacts the return of all data variables of the record. In a telecom environment, or in any other field where decision-making is required in the low millisecond time range, the access time for providing services to subscribers is thus negatively impacted. Furthermore, in the telecom industry there is a requirement for data elements to first identify the subscriber, and then provide extra service that can be postponed until after the subscriber registration is completed. In this instance, there are two levels of data availability required: 1) data elements required to register the subscriber, which are needed very fast, and 2) data elements required to service the customers needs, which may be provided with a certain delay without impacting the subscriber service. Given that the process of registration requires a finite time, if the services data is loaded during this interval, the entire process would require much less time.

An attempt to centralize data storage called CDS (Central Data Storage) has arisen in the last few years in the database industry. In principle, the mechanism caters towards the virtual amalgamation of independent data stored under a single management engine, wherein high-importance data is stored in faster storage means, such as for example in a RAM, while low importance data is stored in slower and cheaper storage means, such as for example HDDs. Retrieval of data involves a two-step process, the first step retrieving the location of the data, and the second retrieving the data. To amalgamate multiple applications into a logical database, a new metafile is created that lists the primary index of the subscriber and the pointer to which the data is stored for each data set. When an application tries to locate the data with respect to the index, one of two things can happen: a) the CDS can transfer the transaction to the referenced database or return the pointer for the application to retrieve the data directly. The CDS can act in both modes depending on the flag set in the transaction request. While this is an interesting step forward, it does not give the flexibility of segmenting each of the data elements in a table into different storage locations, nor treat less available data differently, or provide record locking at the reading of the data pointer, indexing of the pointed to variables or multi-stage data retrieval by the primary database engine.

Reference is now made to FIG. 1 (Prior Art), which is an exemplary representation of a database structure as known in the current implementations. Shown in FIG. 1 are the definitions of four fields 100, 102, 104, and 106 of an information database (not shown). Characteristics of each one of the four fields are defined using field attributes 101, 103, 105, and 107 respectively. For example, attributes 101 define the characteristics of the database field 100, which is therefore of the string type, has eleven (11) characters in length, has a format (layout) as shown, and is found in the primary index of the database. Thus, based on the database definition shown in FIG. 1, a database is created wherein each record comprises four fields having characteristics as defined by the shown attributes. Typically, a database field of a record is stored at a predetermined location, such as for example in a RAM, HDD, etc. When a request is received for retrieving information from a given record, information from each one of the four fields is requested from the database. Therefore, when one of the database fields comprises large amounts of information, such as for example graphical files, the retrieval and the transmission of the information stored in the entire data record to the requestor is slowed down by one of the fields only.

Accordingly, it should be readily appreciated that in order to overcome the deficiencies and shortcomings of the existing solutions, it would be advantageous to have a method and database structure wherein each information element of a given database record can be associated with an access priority information, and wherein information would be returned from the database to querying applications (or users) based on this priority.

The present invention provides such a method and system.

### SUMMARY OF THE INVENTION

In one aspect, the present invention is a method for information database management, the method comprising the steps of:

a. defining one or more data fields for a database structure; and

b. for at least one field of the one or more fields, defining an indication of a priority level of the data contained in the field.

In another aspect, the present invention is an information database structure comprising:

a plurality of data fields; and

an indication of a priority level of the data contained in at least one fields of the plurality of data fields.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is an exemplary representation of a database structure as in the current implementations;

FIG. 2 is an exemplary high-level representation of new metadata used for a new database structure according to the preferred embodiment of the invention;

FIG. 3 is an exemplary high-level representation of a database structure according to the preferred embodiment of the invention;

FIG. 4 is an exemplary high-level block diagram of a database structure according to a 1^{st} exemplary variant of the preferred embodiment of the present invention;

FIG. 5 is an exemplary high-level block diagram of a database structure according to a 2^{nd} exemplary variant of the preferred embodiment of the present invention;

FIG. 6 is an exemplary flowchart diagram of a method for creating a database structure including priority information associated with at least one of the database's fields according to the preferred embodiment of the present invention;

FIG. 7 is an exemplary and high-level block diagram of a database node implementing the preferred embodiment of the present invention; and

FIG. 8 is an exemplary flowchart diagram of a method for retrieving information from a database structure according to the preferred embodiment of the present invention.

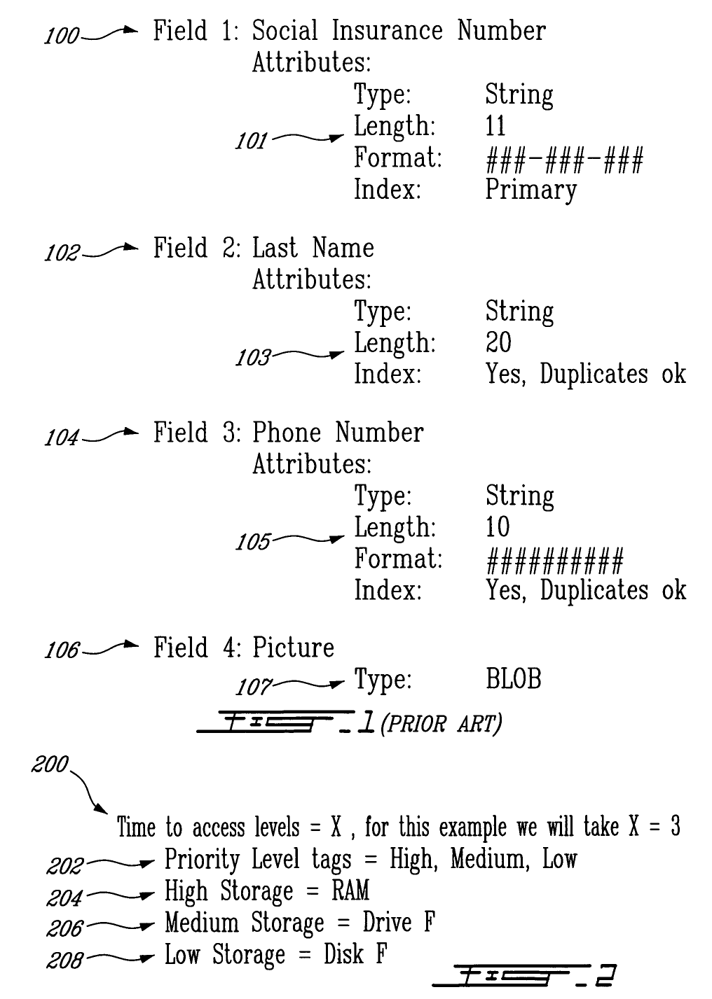

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

According to the present invention, information elements of a database, i.e. the information stored in data fields of the database, are given a priority level, such as for example by being associated with a priority indicator, which can be used for selectively retrieving information form the database based on its priority level. For example, critical data that must be accessed in the fastest possible manner may be stored in high-priority fields of the database, while all the other fields of the database can be given a default, lower, priority indication. When a query for requesting information is received at the database, it is not to the entire record (or records) that matches the query criteria that is retrieved and returned at once. Rather, the retrieval and transmission of the database information is performed in steps: first, only the high priority data fields are read, and their information is returned to the requestor using a 1^{st} query response. In the meantime, lower priority data fields are further read, which may take a longer time since they may contain larger amounts of data that is not necessary to the requestor as fast as the high priority data. When the retrieval of the lower priority data fields is also completed, that information is also returned to the requestor. In this manner, the transmission of the critical data is no longer jeopardized by the delay in accessing the non-critical data fields of the database record.

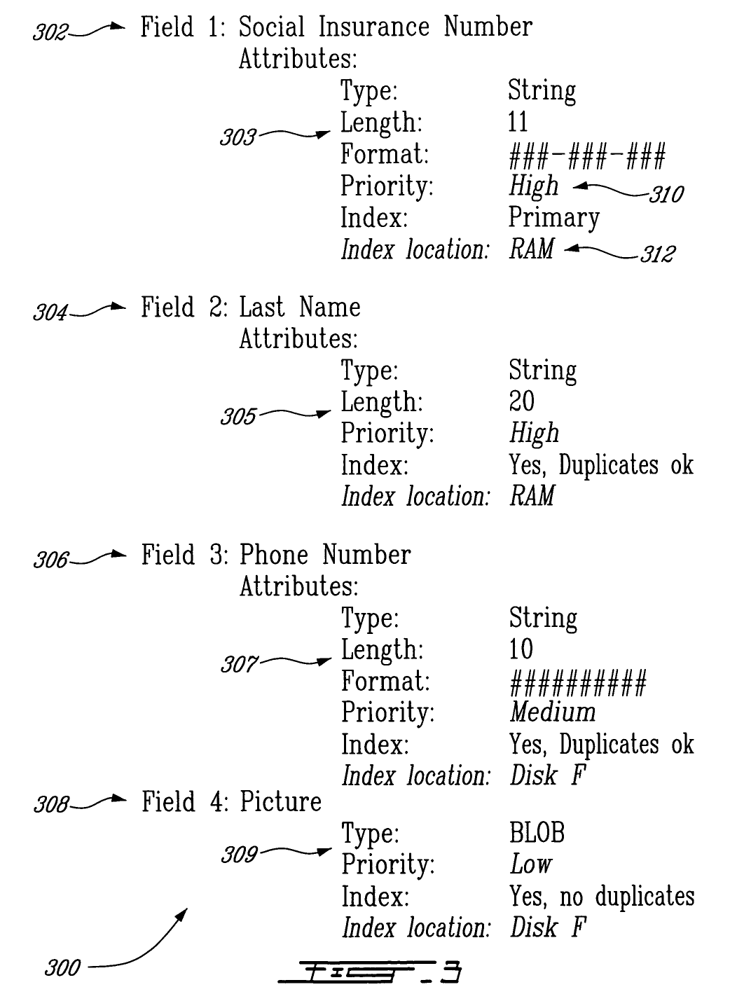

Reference is now made to FIG. 2, which is an exemplary high-level representation of new metadata for a new database structure according to the preferred embodiment of the invention. In FIG. 2, new metadata 200 that may be used for creating a database structure according to the preferred embodiment of the invention is shown as comprising a definition of priority indicators, in the form of priority level tags 202, that may have exemplary values of “High”, “Medium”, or “Low”. The new metadata 200 may optionally further comprise indications 204-208 of the physical location where each information element associated with one of the priority level tags are stored, such as for example the high priority information elements being stored in a Random Access Memory (RAM) that has a very short access time, the medium priority data being stored on local Hard Disk Drive (HDD) F that may have a longer access time, and the low priority information being stored on local HDD F, too.

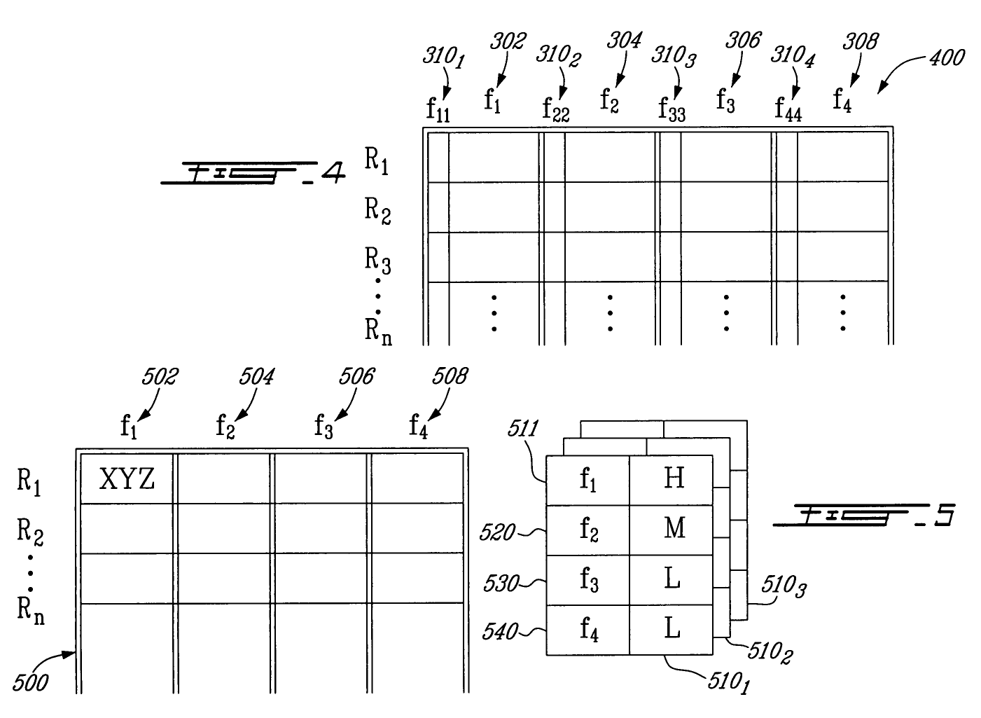

Reference is now made to FIG. 3, which is an exemplary high-level representation of a database structure 300 created using the new metadata 200 described in relation to FIG. 2 according to the preferred embodiment of the invention. It is of course understood that further metadata may be required to create an entire database structure 300, although for simplicity purposes that additional metadata is not shown. The exemplary database structure 300 comprises four different data fields: data field 302 contains the social insurance number information of some clients, the data field 304 contains the last name of the clients, the data field 306 contains the phone number of the clients, and lastly the data field 308 contains the picture of the clients. The characteristics of each one of the four different data fields of the database structure 300 may be defined using data field attributes 303, 305, 307, and 309, respectively, as shown in FIG. 3. Because of the new metadata 200 of the present invention, each one of the data fields 302, 304, 306, and 308 includes an attribute related to the priority level of the information stored in that data field. For example, data field 302 has its priority attribute 310 set to the level “High”, which means that data contained in that field is of high priority and should be returned first when requested by a query. The same data field 302 may also comprise an index location attribute 312 that specifies the physical location where the data contained in that field is stored, i.e. in the RAM. Likewise, all the other fields 304, 306, and 308 may also have priority attributes and location attributes that specify the priority of the data they contain and the physical location where their data is stored. It is also understood that according to the invention, not all the data fields of a given database or of a given table must be given a priority information or contain an index location indicator. For example, it may rather be possible that only certain ones of the database or table fields are given a “High” priority indicator, while others have no priority indication at all.

Reference is now made to FIG. 4, which is an exemplary high-level block diagram of a database structure 400 according to a 1^{st} variant of the preferred embodiment of the present invention. Based on the new metadata 200, a database 400 is created, wherein the database 400 may comprise one or more database tables and wherein one of the tables of the database comprises, for example, the exemplary database fields 302, 304, 306, and 308, as well as a plurality of records R1-Rn. For each such record, the database 400 may comprise data field priority indications 310ᵢ, as described hereinbefore. The data field priority information may take the form of field attributes 310ᵢ as described hereinabove, or may have also other nature such as location of where data is stored, or a function associated with teach such data field.

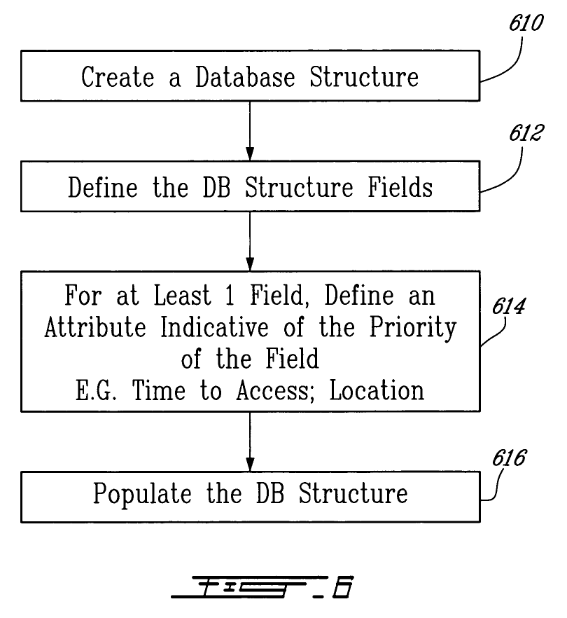

FIG. 5 is an exemplary high-level block diagram of a database structure according to a 2^{nd} variant of the preferred embodiment of the present invention. According to second variant of the preferred embodiment of the invention, a database structure comprises a database table 500 for storing database information. In the present exemplary scenario it is also assumed that the table to 500 comprises four table fields 502, 504, 506, and 508 and a plurality of records R1-Rn, wherein the table 500 stores data of various kinds. The database structure further comprises another one or more tables 510 that store the priority levels indication associated with one or more of the fields 502-508, or at least of some of the mentioned fields. In this implementation, a link exists between the fields of the table 500 and the table 510, thus insuring a proper representation of the priority indicator associated with each field of the database. For example, the data “xyz” stored in the field 502 of the record R1 of the table 500 may be linked to the first entry 511 “H” of the table 510,, which indicates a “High” level of priority associated with data “xyz” contained in that field. Likewise, the other entries 520, 530, and 540 of the table 510₁ provide priority levels indications related to the remaining three fields 504, 506, and 508 of the record R1 of the table 500. In analogous manner, the other tables 510ᵢ may provide priority information related to the other records R2-Rn of the table 500. In an alternative embodiment, only one table 510 exists for defining the priority level indications of data fields of a given table or database 500.

Other possibilities to include priority level indications related to one or more fields of a given in database structure, or table comprised in a database structure, may further exists.

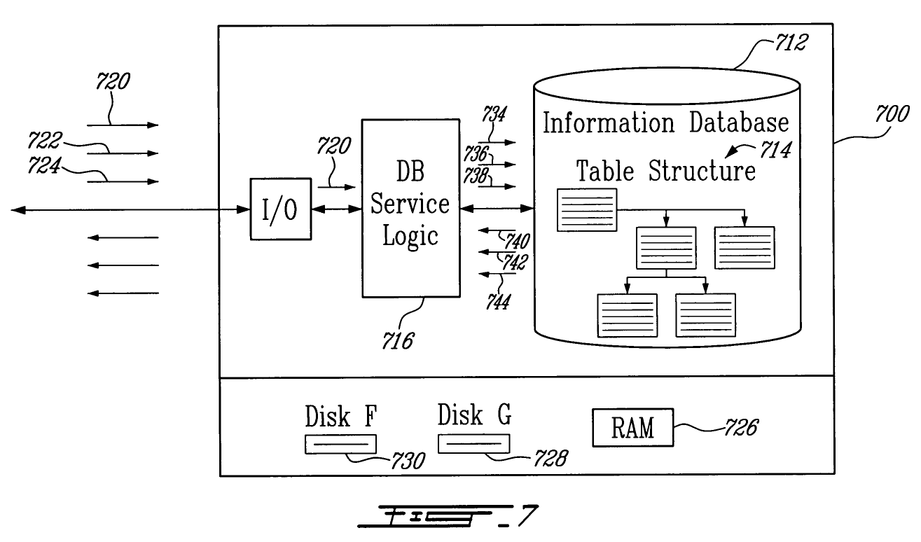

Reference is now made to FIG. 6, which is an exemplary flowchart diagram of a method for creating a database structure including priority level indications associated to at least one of the database fields according to the preferred embodiment of the present invention. In FIG. 6 first, in step 610, a database structure may be created, such as for example by a system administrator using a software program capable of creating a database. In action 612, the system administrator may further create and define database fields and, in action 614 the administrator may further define for at least one of the fields an attribute that is indicative of the priority of that data field. For example, the system administrator may define a database structure as the one represented in FIG. 3, wherein at least one table field comprises a priority level indication associated with that field. The indication may comprise an explicit priority level indication (e.g. “High”, “Low” Priority level), and/or an implicit priority level indication such as for example index location information indicative of the physical location where the data of that field is to be stored. Finally in action 616, the database can be populated with data.

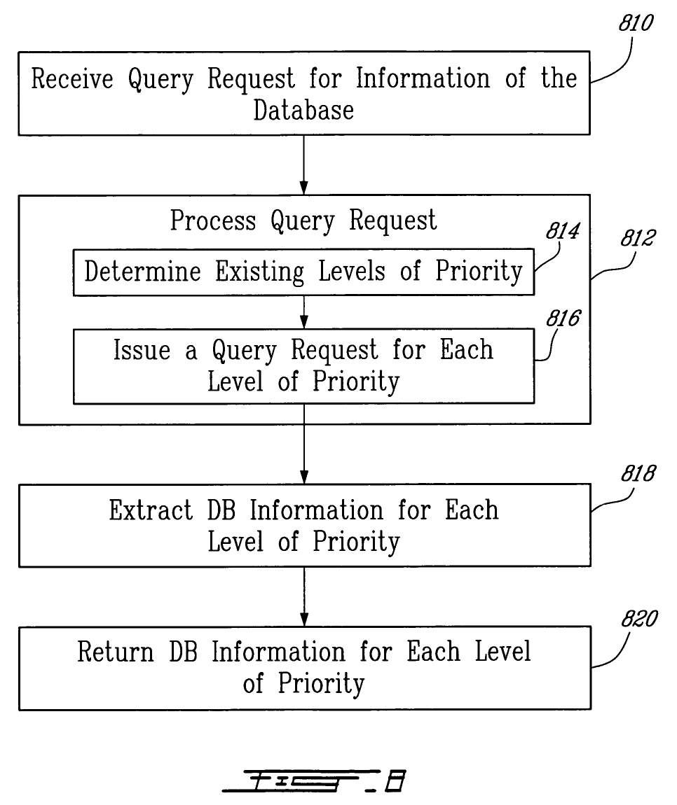

Reference is now made to FIG. 7, which is an exemplary high-level block diagram of a database node 700 implementing the preferred embodiment of the present invention. Shown in FIG. 7, is a database structure 712 which function may be to store data of various kinds, such as for example subscriber records, subscriber profile and other type of information associated with subscriber. The information database 712 may comprise a table structure 714 that may take various forms and which may include one or more database tables that may be linked among each other in various combinations. Connected to the information database 712 may be a database service logic 716 responsible for processing query requests 720, 722, and 724 that may originate from various requester nodes of a telecommunications network (not shown) and which request information from the database 712. Also comprised in the database node 700 are or more storage media, such as for example the RAM 726, HDD drive G 728, and HDD drive F 730, which may each store one or more portions of information of the database 712. It is understood that in connection with the presently described exemplary scenario, at least a portion of the data stored in the database 712 has associated priority level information, as described hereinbefore. For example, at least some of the fields of a table of the table structure 714 of the database 712 may have been assigned priority level indications during the creation or the set-up of the table structure 714.

Reference is now made jointly to FIG. 7, previously described, and to FIG. 8, which is an exemplary flowchart diagram of a method for retrieving information from the database 712 according to the preferred embodiment of the present invention. In action 810, a query request 720 for information of the database 712 is received at the database node 700, wherein the request 720 may comprise criteria for retrieving certain information of the database 712, as it is known in the art. The query request 720 reaches the database service logic 716, where it is processed, action 812. This may comprise action 814 of determining the existing levels of priority of the data stored in the database 712, such as for example determining that the data of the database 712 has three possible levels of priority: “High”, “Medium”, and “Low”. Action 812 may further comprise issuing, based on the query request 720 that contained the criteria for the desired data, a query request for each such level of priority, action 816, i.e. translating the query request 720 in three different query requests 734, 736, and 738, wherein the query request 734 requests from the database 712 the data that matches the given criteria and which priority level is set to “High”, the query request 736 requests from the database 712 the data that matches the given criteria and which importance is set to “Medium”, and the query request 738 requests from the database 712 the data that matches the given criteria and which importance is set to “Low”. When each one of the query requests 734-738 reaches the database 712, data that matches the given criteria and that level of priority is returned back from the database 712, to the database service logic 716 in correspondent query responses 740, 742, and 744 respectively, action 818. Typically, the data that has a “High” priority level is returned first because it is easier to access, while data having a “Medium” priority level is returned next and the data having a “Low” priority level is returned lastly, since it may comprise the larger portions of data. The query responses 740-744 are then relayed back from the database service logic 716 to the requestor (not shown) in the order they reached the data service logic 716, action 820. In this manner, by implementing levels of priority associated with portions of data stored in the database 712, the critical data given a “High” priority level can be returned faster to the requester, while lower priority data that may comprise larger portions of data that are more difficult to access and less essential to the requester, are returned only when they become available to the requester, which will no longer slow down the overall processed of extracting and returning the data to the requester.

Therefore, with the present invention it becomes possible to request data from a given database, and to translate the request into a plurality of requests, wherein each such request is destined to data of a given priority level. In this manner, the invention allows to access critical portions of information (that are assigned a high priority level) from a database in a faster manner, while less important portions of the data that may take a longer time to be retrieved may be accessed and returned with a longer delay.

Based upon the foregoing, it should now be apparent to those of ordinary skills in the art that the present invention provides an advantageous solution, which offers improved access time to critical information of database. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for information database management, the method comprising the steps of:
a. defining one or more data fields for a database structure; and
b. for at least one field of the one or more fields, defining an indication of a priority level of the data contained in the field.

2. The method claimed in claim 1, further comprising before step a. the step of:
c. creating the database structure.

3. The method claimed in claim 1, wherein the indication comprises an attribute of the at least one field, the attribute being indicative of the priority level.

4. The method claimed in claim 1, wherein the indication is comprised in a table of the database structure where the data of the at least one field is also stored.

5. The method claimed in claim 1, wherein the indication is comprised in a first table of the database structure and the data of the at least one field is stored in a second table of the database structure, wherein the first and second table are linked together.

6. The method claimed in claim 1, wherein the indication comprises an attribute of the at least one field, the attribute being indicative of an index location of data contained in the at least one field.

7. The method claimed in claim 1, further comprising the steps of:
c. receiving a query request for information of the database structure;
d. determining priority levels relative to data of the database structure; and
e. translating the query request into a plurality of query requests, wherein each one of the query requests asks for database information having one priority level of the determined priority levels of the data of the database structure.

8. The method claimed in claim 7, further comprising the steps of:
f. responsive to the plurality of query requests, individually extracting data that matches the determined priority levels of the database structure; and
g. returning in separate query responses the data that matches the determined priority levels.

9. A database structure comprising:
a plurality of data fields; and
an indication of a priority level of the data contained in at least one field of the plurality of data fields.

10. The information database structure claimed in claim 9, wherein the indication comprises an attribute of the at least one field, the attribute being indicative of the priority level.

11. The information database structure claimed in claim 9 further comprising:
a table storing the data of the at least one field and the indication.

12. The information database structure claimed in claim 9 further comprising:
a first table storing the indication; and
a second table storing the data of the at least one field;
wherein the first and second table are linked together.

13. The information database structure claimed in claim 9, wherein the indication comprises an attribute of the at least one field, the attribute being indicative of an index location of data contained in the at least one field.

14. The information database structure claimed in claim 9, the database structure further comprising:
database serviced logic acting to receive a query request for information of the database structure, the database service logic further acting to determine priority levels relative to data of the database structure and to translate the query request into a plurality of query requests;
wherein each one of the plurality of query requests asks for database information having one priority level from the determined priority levels of the data of the database structure.

15. The information database structure claimed in claim 14, wherein responsive to the plurality of query requests, data that matches each one of the determined priority levels of the database structure is individually extracted from the database structure and is returned to a requestor.
